(19) United States
(12) Patent Application Publication
(10) Pub. No.: US 2025/0191332 A1
(43) Pub. Date: Jun. 12, 2025

(54) FEATURE DETECTION IN MULTI-MODAL AND MULTI-DIMENSIONAL DATA

(71) Applicant: Intuitive Research and Technology Corporation, Huntsville, AL (US)

(72) Inventors: Michael Lee YOHE, Madison, AL (US); Charles Thomas ETHEREDGE, Huntsville, AL (US); Kyle Jordan RUSSELL, Huntsville, AL (US)

(21) Appl. No.: 18/965,984

(22) Filed: Dec. 2, 2024

Related U.S. Application Data
(60) Provisional application No. 63/607,674, filed on Dec. 8, 2023.

(51) Int. Cl. G06V 10/40; G06F 16/28; G06F 16/54; G06F 16/55; G06T 11/20; G06V 10/774

(52) U.S. Cl. CPC G06V 10/513; G06F 16/288; G06F 16/54; G06F 16/55; G06T 11/206; G06V 10/774

(57) ABSTRACT

Techniques for identifying features within a dataset are disclosed. An original set of data is accessed. This data set is dimensionally reduced by performing a dimensional reduction operation. The dimensionally reduced data set is plottable in a coordinate system as a result of the dimensional reduction operation being performed. The dimensionally reduced data set is plotted in the coordinate system, resulting in generation of a visual plot of the dimensionally reduced data set. Perspective views of the plot are modified in an attempt to identify a feature. In response to a particular feature being identified, the original set of data is sampled to identify a data relationship that exists within the original set of data. This data relationship is one that contributed to the feature being detectable.

### CROSS-REFERENCE TO RELATED APPLICATIONS

This application claims the benefit of and priority to U.S. Provisional Patent Application Ser. No. 63/607,674 filed on Dec. 8, 2023 and entitled “FEATURE DETECTION IN MULTI-MODAL AND MULTI-DIMENSIONAL DATA,” which application is expressly incorporated herein by reference in its entirety.

### BACKGROUND

“Computer vision” refers to the use of computers to identify “features” present in images or visualizations and then correlate those features into objects that have those features. Notably, a “feature” is a recognizable region of interest in the visualization, and the feature is recognizable because it has certain properties.

As some simplistic examples, a feature may be a point or an edge of an object, as displayed in the visualization. These features can be used to help identify the object.

For instance, consider a scenario in which an image portrays a table. The image can be analyzed to identify a linear edge. A human can readily discern that edge as being the edge of the table, but computer vision does not have the intuition of a human. Instead, the computer vision algorithm will analyze the linear edge, determine its feature characteristics, and then use that feature to try to identify and recognize the table.

Recognizing features allows computers to generalize different aspects of images. It also allows computers to be trained on what features are attributable to objects and to try to find the best matches of objects based on those features. These images are often in two dimensions (2D) (e.g., width and height) with an additional dimension that features a color value (regardless of a black and white or color image).

While images are relatively straightforward to analyze for feature detection, there are also datasets that exist in multiple dimensions (nD) that present significant challenges for computer vision algorithms to find features. Dimensional reduction operations can be performed in an attempt to reduce the number of dimensions of the dataset so as to improve the chances of identifying features. Challenges still exist, however, with identifying features in that dataset.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

In some aspects, the techniques described herein relate to a method including: accessing an original set of data having a plurality of disparate data types; generating a dimensionally reduced data set by performing a dimensional reduction operation on the original set of data, wherein the dimensionally reduced data set is plottable in a coordinate system as a result of the dimensional reduction operation being performed; plotting the dimensionally reduced data set in the coordinate system, resulting in generation of a visual plot of the dimensionally reduced data set; dynamically modifying perspective views of the plot in an attempt to identify one or more features that are visually detectable via a computer vision algorithm, wherein the one or more features include multiple portions of the dimensionally reduced data set, said multiple portions being grouped together to form the one or more features based on the perspective views of the plot being dynamically modified; in response to identifying a particular feature, sampling the original set of data to identify a data relationship that exists within the original set of data, said data relationship being one that contributed to the feature being detectable; and triggering a re-training of the computer vision algorithm based on the identified data relationship.

In some aspects, the techniques described herein relate to a computer system including: a processor system; and a storage system that stores instructions that are executable by the processor system to cause the computer system to: access an original set of data having a plurality of disparate data types; generate a dimensionally reduced data set by performing a dimensional reduction operation on the original set of data, wherein the dimensionally reduced data set is plottable in a coordinate system as a result of the dimensional reduction operation being performed; plot the dimensionally reduced data set in the coordinate system, resulting in generation of a visual plot of the dimensionally reduced data set; dynamically modify perspective views of the plot in an attempt to identify one or more features that are visually detectable via a computer vision algorithm, wherein the one or more features include multiple portions of the dimensionally reduced data set, said multiple portions being clustered together to form the one or more features based on the perspective views of the plot being dynamically modified; in response to identifying a particular feature as viewed from a particular perspective view of the plot, sample the original set of data to identify a data relationship that exists within the original set of data, said data relationship being one that contributed to the feature being detectable; and trigger a re-training of the computer vision algorithm based on the identified data relationship.

In some aspects, the techniques described herein relate to a method including: accessing an original set of data having a plurality of disparate data types; generating a dimensionally reduced data set by performing a dimensional reduction operation on the original set of data, wherein the dimensionally reduced data set is plottable in a coordinate system as a result of the dimensional reduction operation being performed; plotting the dimensionally reduced data set in the coordinate system, resulting in generation of a visual plot of the dimensionally reduced data set; dynamically modifying perspective views of the plot in an attempt to identify one or more features that are visually detectable, wherein the one or more features include multiple portions of the dimensionally reduced data set, said multiple portions being grouped together to form the one or more features based on the perspective views of the plot being dynamically modified; and in response to a particular feature being identified, sampling the original set of data to identify a data relationship that exists within the original set of data, said data relationship being one that contributed to the feature being detectable.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates an example computing architecture that can detect features in plotted data.

FIGS. 2A, 2B, and 2C illustrate an example scenario in which different perspective views of data can lend to the detection of features.

FIGS. 3A through 3J illustrate an example scenario showing how to dynamically modify the perspectives of plotted data to identify features.

FIG. 4 illustrates a flowchart of an example method for detecting features.

FIG. 5 illustrates an example computer system that can be configured to perform any of the disclosed operations.

### DETAILED DESCRIPTION

As mentioned earlier, datasets can be dimensionally reduced to fit a conventional three dimensional (3D) global structure. That dataset can then be rotated in any dimension so as to change the perspective from which it is viewed. These actions, however, continue the problem of having infinite perspectives at which a dataset can be viewed.

The disclosed embodiments are designed to solve problems that arise when feature detection is performed using multi-modal and multi-dimensional data. Generally, the disclosed embodiments access this multi-modal and multi-dimensional data. The embodiments aggregate that data and then perform one or more dimensional reduction operations on the data. This data is then plotted in a coordinate system, such as perhaps a 3D global structure.

The embodiments are then tasked with modifying the perspective views of the plot in an attempt to identify one or more features embodied within the plotted data. As these features are identified, the embodiments can make inferences regarding the features and then trigger the re-training or tuning of the computer vision algorithm so that the algorithm can better search for features going forward. Additional training can also be performed regarding which perspective modifications resulted in the detection of features.

The disclosed embodiments bring about numerous benefits, advantages, and practical applications to the technical field of data analytics and machine learning training. Historically, it has been a significant challenge to analyze disparate data types and to try to find correlations or relationships within that data. For instance, in scenarios involving a one-to-one data relationship, identifying those relationships is relatively straightforward. In scenarios involving one-to-many data relationships, those relationships are also oftentimes straightforward to identify. The ease of identifying relationships breaks down in scenarios involving many-to-many data relationships. It is with these scenarios (e.g., many-to-many) that the embodiments provide significant improvements. Indeed, the embodiments are able to quickly and efficiently identify relationships in data and can enable those relationships to be used to further train a computer vision algorithm. Accordingly, these and numerous other benefits will now be described in more detail in the following sections of this disclosure.

### Example Architecture

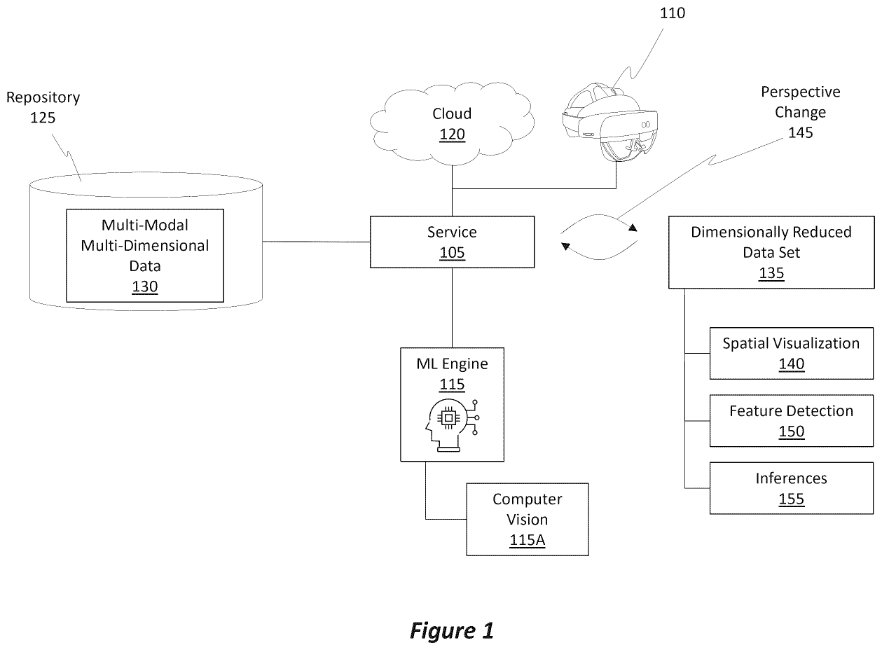

Having just described some of the high level benefits, advantages, and practical applications achieved by the disclosed embodiments, attention will now be directed to FIG. 1, which illustrates an example computing architecture 100 that can be used to achieve those benefits.

Architecture 100 includes a service 105, which can be implemented by an extended reality (XR) system 110 comprising a head mounted device (HMD). Service 105 can also be implemented on any other type of computer system. That is, the disclosed principles can be employed on a traditional computing system having a traditional screen, but they can also be employed using an HMD. As a result, the disclosed principles are agnostic in terms of the type of device they can be implemented on.

The phrase “extended reality” (XR) is an umbrella term that collectively describes various different types of immersive platforms. Such immersive platforms include virtual reality (VR) platforms, mixed reality (MR) platforms, and augmented reality (AR) platforms. The XR system provides a “scene” to a user. As used herein, the term “scene” generally refers to any simulated environment (e.g., three-dimensional (3D) or two-dimensional (2D)) that is displayed by an XR system.

For reference, conventional VR systems create completely immersive experiences by restricting their users' views to only virtual environments. This is often achieved through the use of an HMD that completely blocks any view of the real world. Conventional AR systems create an augmented-reality experience by visually presenting virtual objects that are placed in the real world. Conventional MR systems also create an augmented-reality experience by visually presenting virtual objects that are placed in the real world, and those virtual objects are typically able to be interacted with by the user. Furthermore, virtual objects in the context of MR systems can also interact with real world objects. AR and MR platforms can also be implemented using an HMD. XR systems can also be implemented using laptops, handheld devices, and other computing systems.

Unless stated otherwise, the descriptions herein apply equally to all types of XR systems, which include MR systems, VR systems, AR systems, and/or any other similar system capable of displaying virtual content. An XR system can be used to display various different types of information to a user. Some of that information is displayed in the form of a “hologram.” As used herein, the term “hologram” generally refers to image content that is displayed by an XR system. In some instances, the hologram can have the appearance of being a 3D object while in other instances the hologram can have the appearance of being a 2D object.

Regarding the plotted data mentioned earlier, these plots can be displayed on the computer screen, or they can be displayed in a virtual environment using the HMD. That is, the plot can be displayed in the form of holograms. When implemented using the HMD, the user can immerse him/herself directly into the plot and can attempt to assist the computer vision algorithm in identifying features.

Returning to FIG. 1, as used herein, the term “service” refers to an automated program that is tasked with performing different actions based on input. In some cases, service 105 can be a deterministic service that operates fully given a set of inputs and without a randomization factor. In other cases, service 105 can be or can include a machine learning (ML) or artificial intelligence engine, such as ML engine 115. The ML engine 115 enables the service to operate even when faced with a randomization factor, and the ML engine 115 may include a computer vision 115A component or algorithm.

As used herein, reference to any type of machine learning or artificial intelligence may include any type of machine learning algorithm or device, convolutional neural network(s), multilayer neural network(s), recursive neural network(s), deep neural network(s), decision tree model(s) (e.g., decision trees, random forests, and gradient boosted trees) linear regression model(s), logistic regression model(s), support vector machine(s) (“SVM”), artificial intelligence device(s), or any other type of intelligent computing system. Any amount of training data may be used (and perhaps later refined) to train the machine learning algorithm to dynamically perform the disclosed operations.

In some implementations, service 105 is a cloud service operating in a cloud 120 environment. In some implementations, service 105 is a local service operating on a local device, such as the XR system 110. In some implementations, service 105 is a hybrid service that includes a cloud component operating in the cloud 120 and a local component operating on a local device. These two components can communicate with one another.

Service 105 is able to access a repository 125 comprising multi-modal multi-dimensional (MMMD) data 130. As used herein, the phrase “multi-modal” data generally refers to data that can span different data types and different data contexts (e.g., text, images, video, etc.). As used herein, the phrase “multi-dimensional” data generally refers to data that has more than one dimension (e.g., multiple data columns, features, or attributes).

The MMMD data 130 can include data of any type. Examples of such data types include, but are not limited to, any type of sensor data, analytic data, metric data, measurement data, characteristic data, and so on without limit.

As a simplistic example, consider a scenario involving a flight that crosses the Atlantic Ocean. In this particular example, the MMMD data 130 may include the speed measurements of the plane, the weight characteristics of the plane, the number of passengers on the plane, the number of cocktails sold during the flight, the duration of the flight, the number of flight attendants on the flight, the number of children on the flight, the number of emergency doors on the airplane, the movies that were played during the flight, the duration of the movies that were played, and perhaps even the number of times a passenger reached for his/her carry-on luggage. As a result, the MMMD data 130 is an original set of data having multiple disparate data types.

Service 105 is configured to generate a dimensionally reduced data set 135 by performing a dimensional reduction operation on the MMMD data 130. As used herein, the phrase “dimensional reduction” (aka “dimensionality reduction”) refers to a transformative process in which a higher-dimensional set of data is transformed or reduced into a lower-dimensional set of data. This lower-dimensional set of data is designed in a manner so that it retains at least some meaningful properties of the higher-dimensional set of data. In other words, the dimensional reduction operation reduces the number of input variables in the original set of data, resulting in the generation of the dimensionally reduced data set.

After dimensionally reducing the data, service 105 then plots the dimensionally reduced data set 135 in a coordinate system, such as a 3D global structure. As a result, the dimensionally reduced data set 135 is provided with a spatial visualization 140 in the form of the plot.

After the data is plotted, service 105 then performs various operations that change the perspective views of the plotted data, as shown by perspective change 145. These changes can be of any type. For example, the perspective changes can be changes in how the data is viewed along any of the x-axis, y-axis, or z-axis. The perspective changes can also include zooming operations, such as zoom in operations or zoom out operations. The perspective changes can also include bisections of the plotted data, or even any type of selective filtering of the data (e.g., noise reduction).

By way of further explanation, the technique of bisection works extremely effectively to help identify features embedded within the data. For example, the embodiments can rotate the plot in any direction. If no features are identified, the embodiments can optionally bisect the plot and then shift perspective again. The embodiments can shift the starting perspective by an arbitrary amount any number of times. If a feature is detected, the embodiments can mark the perspective and then perform additional modifications to the plot, such as sharpening the resolution of the plot or even reducing the resolution of the plot. Additional bisection operations can also be performed in an attempt to further clarify features that may be found. Also, the axis rotation point by which the plot is rotated can also be changed.

As one example, it may be the case that the plot is originally rotated about a central axis of the plot. Later, the axis rotation point may be shifted, such as perhaps to an upper right quadrant of the plot. Rotations based on this new axis rotation point and even bisections based on this new axis rotation point can be made in an attempt to identify features.

While the plotted data is displayed in these various different perspectives, service 105 employs the use of the computer vision 115A algorithm in an attempt to identify visual features within the plotted data, as shown by feature detection 150. If a feature is identified, inferences 155 can then be made by the service 105. For instance, these inferences 155 can include relationships among the data or insights into what the data represents or insights as to how one variable affects other variables.

By way of further detail regarding the disparate data (e.g., the MMMD data 130), it is often the case that humans might not be able to recognize any pattern or relationship that exists between the data. By performing the disclosed operations (e.g., including the dimensionality reduction, the plotting in visual space, and the perspective manipulation until the computer vision can identify a feature), it is now possible to readily identify relationships in the disparate data that were perhaps unrecognizable previously. Additional inferences and predictions, or even other actions (e.g., perhaps therapeutic or preventive actions), can now be performed based on the now-recognized relationships that exist in the data.

One value proposition of the disclosed principles is that the embodiments can operate orders of magnitude faster than traditional techniques involving data scientists. For instance, what the embodiments facilitate in a few minutes, it has historically taken teams of data scientists days, weeks, or even months to accomplish. Generally, one objective is to identify relationships among the data and then attempt to explain those relationships mathematically. Using the disclosed principles, the embodiments are able to operate on disparate data sets (without prior explanations or a frame of reference), run their algorithms, facilitate a visual inspection, and then derive a result (in mere minutes), which would historically take a significant amount of time.

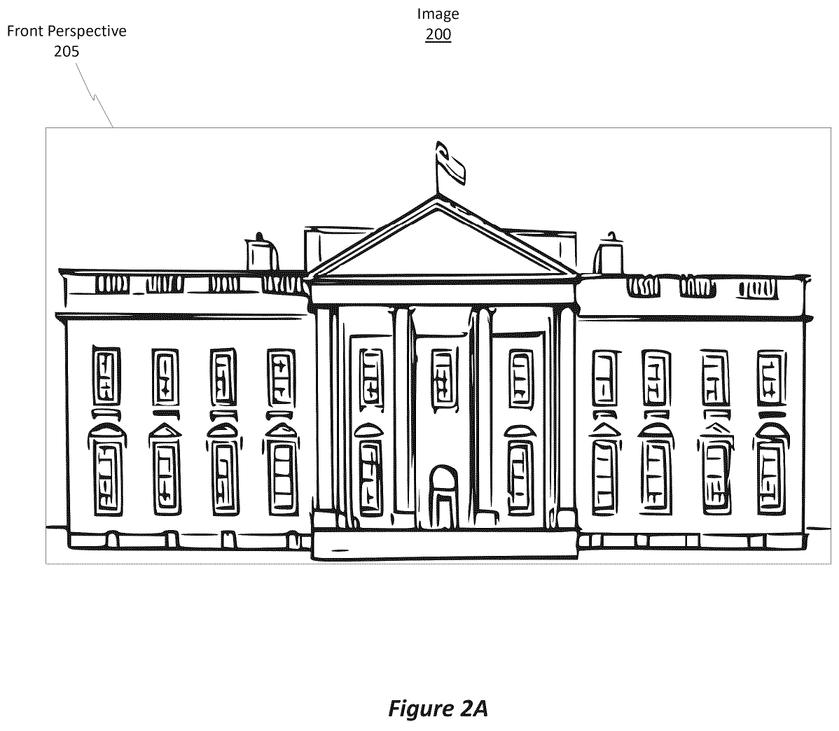

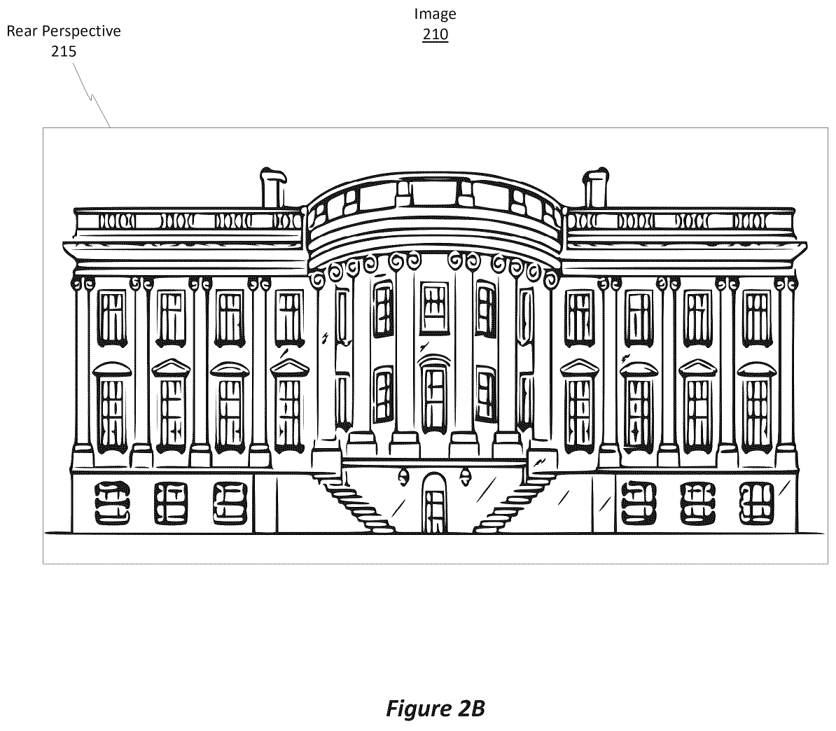

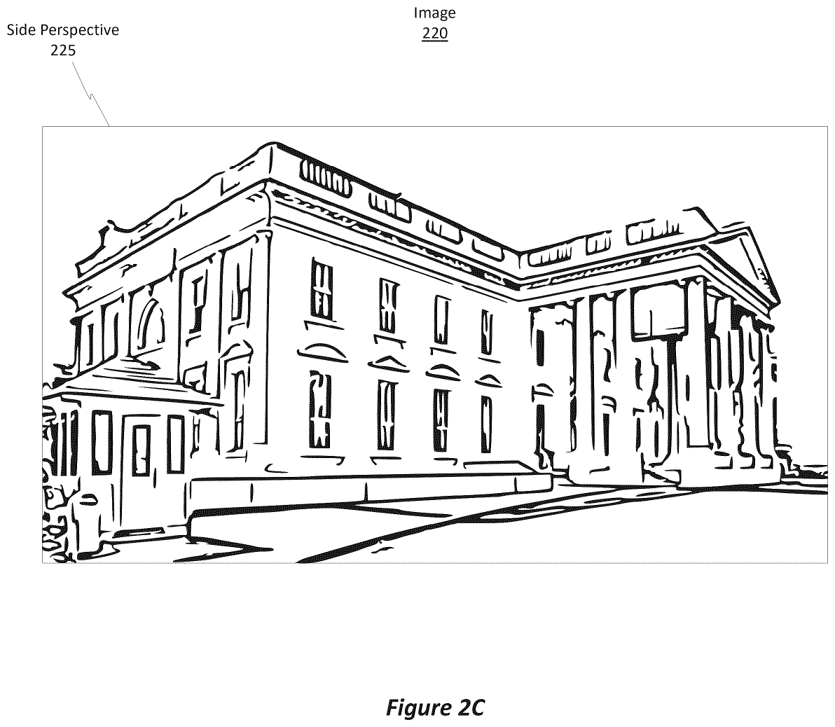

Consider the example shown in FIGS. 2A, 2B, and 2C. FIG. 2A shows an image 200, which is a front perspective 205 of the White House in the United States. This building is widely recognizable by many people in the world. Similarly, computer vision algorithms would likely be able to recognize this famous building.

FIG. 2B shows another image 210, which is a rear perspective 215 of the White House. Again, this perspective is widely famous and is generally recognizable by humans and computer vision.

Now, consider the image 220 of FIG. 2C. Image 220 shows a side perspective 225 of the White House. As compared to the number of people that would recognize the structure shown in images 200 and 210, the number of people that would recognize the structure shown in image 220 is likely much lower. Similarly, computer visional algorithms may be less likely to accurately identify the structure shown in image 220. Yet, by modifying the perspective of the structure (e.g., to that shown in either image 200 or image 210), the likelihood of recognition would be significantly increased. The disclosed embodiments are beneficially able to facilitate operations that involve data perspective modifications to thereby increase the likelihood of identifying worthwhile features and relationships.

Some additional examples may be helpful. Consider a health-based scenario in which a person's daily health regimen is entered as input. This health regimen may include the person's sleep schedule, the type of bed the person sleeps on, the food the person consumes throughout the day, the time of the food consumption, the person's exercise habits, and the person's job description. One will appreciate how this data set includes multiple disparate data types. The disclosed embodiments are able to perform a dimensional reduction operation on the data and then plot the resulting data. The embodiments then dynamically modify the perspective of the plot in an attempt to identify features within the data. In some cases, additional filtering and processing of the data may be performed, and the perspectives of that data can similarly be modified. The goal is to identify a visual feature represented within the plotted data. This visual feature can then be further analyzed in an attempt to identify relationships in the data, where these relationships previously may not have been recognizable.

As another example, consider a scenario where a person has a pathological illness, such as a case where the person suffers randomly from seizures. The embodiments are able to acquire the daily habits of the person and perform the disclosed operations using that data. Features may then be identified, and it may be the case that those features can help identify a specific reason or triggering condition that causes the person to have seizures. Based on these findings, certain preventative actions can then be employed by the person in an attempt to avoid triggering conditions that may lead to the onset of a seizure.

As yet another example, consider a scenario where a plane has crashed for a seemingly unknown reason (or yet unknown reason). Data can be collected for that plane, including data prior to the crash and data after the crash (e.g., perhaps describing the scatter of the plane crash). This data can be analyzed in accordance with the disclosed principles to identify features and relationships within the data. It may be the case that these relationships can then be used to infer a reason as to why the plane crashed.

Historically, dimensionality reduction has been used to simplify mathematical equations in an attempt to generate correlations. The disclosed embodiments are taking an additional step forward with regard to the use of dimensionality reduction. Beneficially, the embodiments are using dimensionality reduction to plot data and to identify previously unrecognized correlations in the data, thereby leading to an improved analysis of the data.

It should also be noted how the disclosed embodiments can implement a type of feedback loop to further train the ML engine 115, and in particular the computer vision 115A, based on the features that have been found. This further training can help the computer vision 115A in its subsequent actions to identify features within data sets and to continuously improve its model.

Improvements and further training to other machine learning models can be performed as well. For instance, behavioral data of a first machine learning model can be collected and fed as input to the disclosed service 105. Service 105 may then perform the disclosed operations on that behavior data to recognize trends or behaviors of that first machine learning model and to identify other features. Having recognized these features, service 105 can then trigger the first machine learning model to be retrained in an effort to improve its functionality.

### Example Scenarios

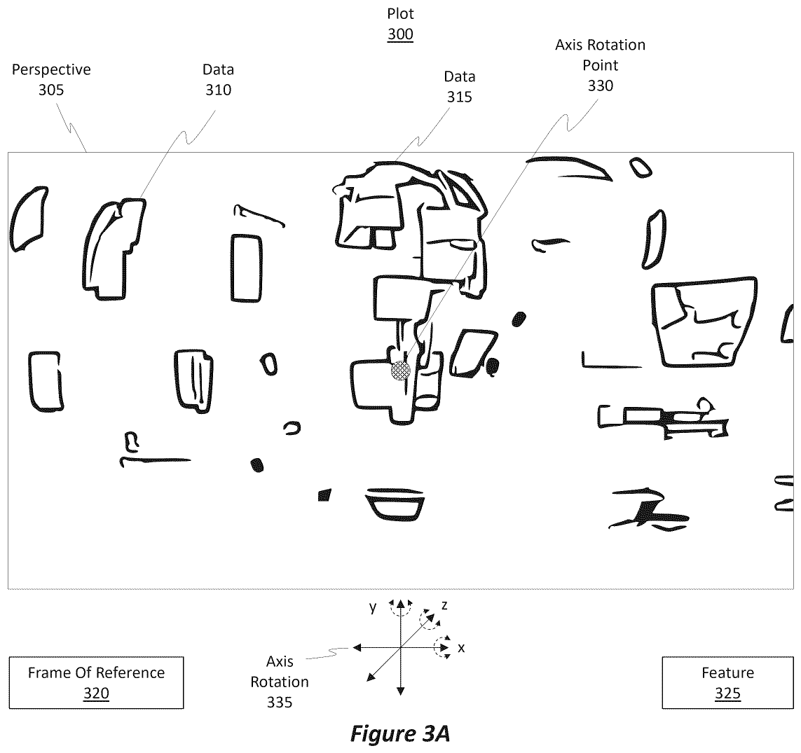

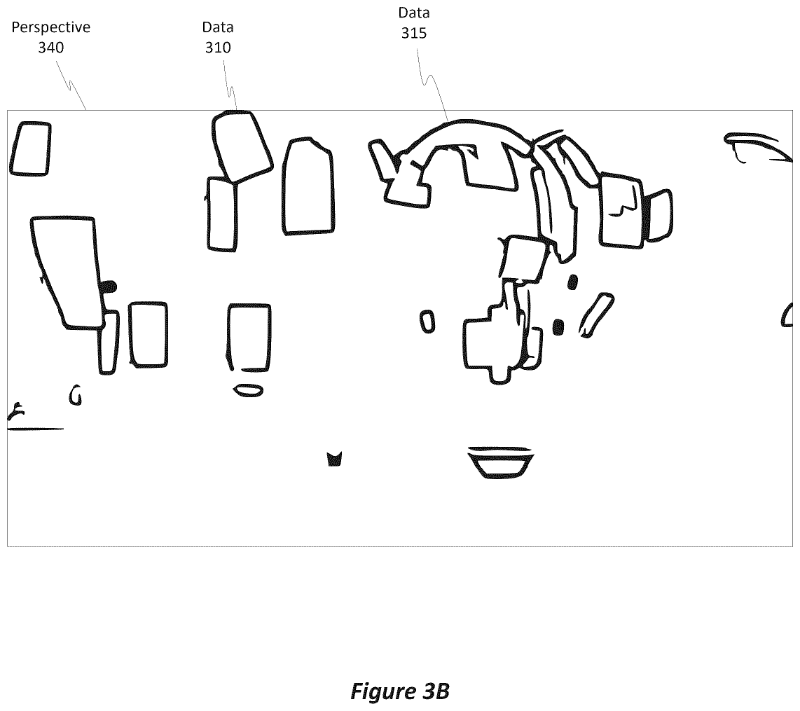

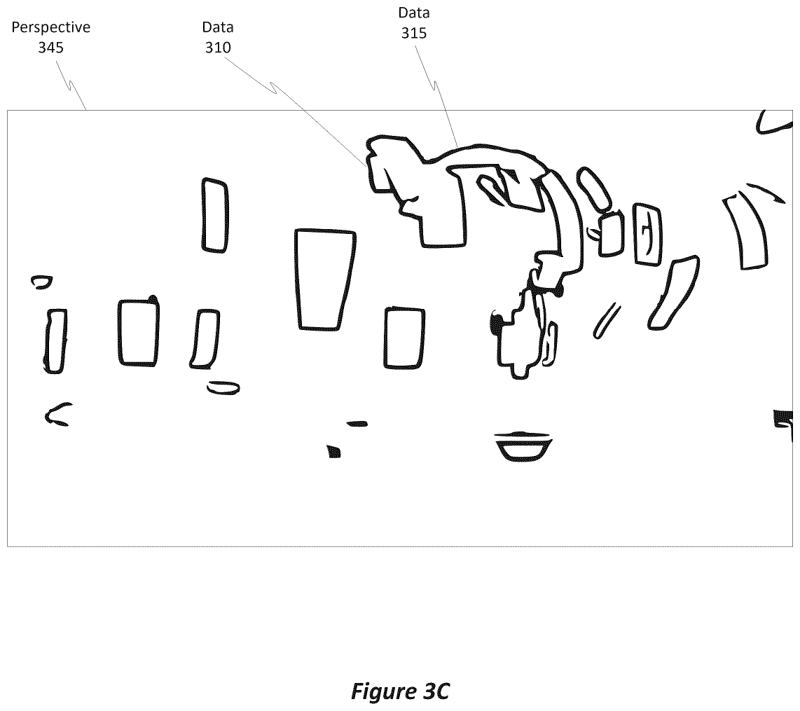

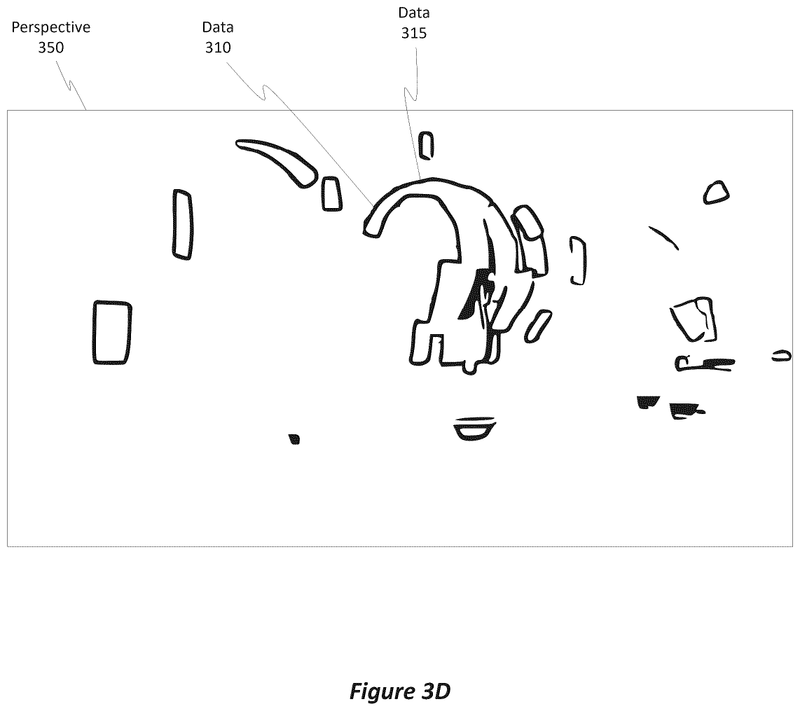

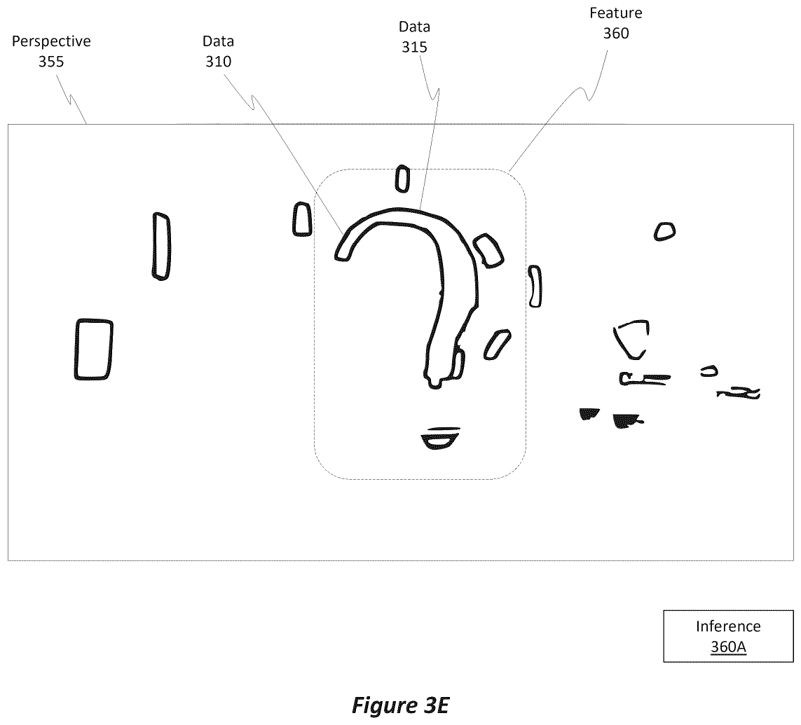

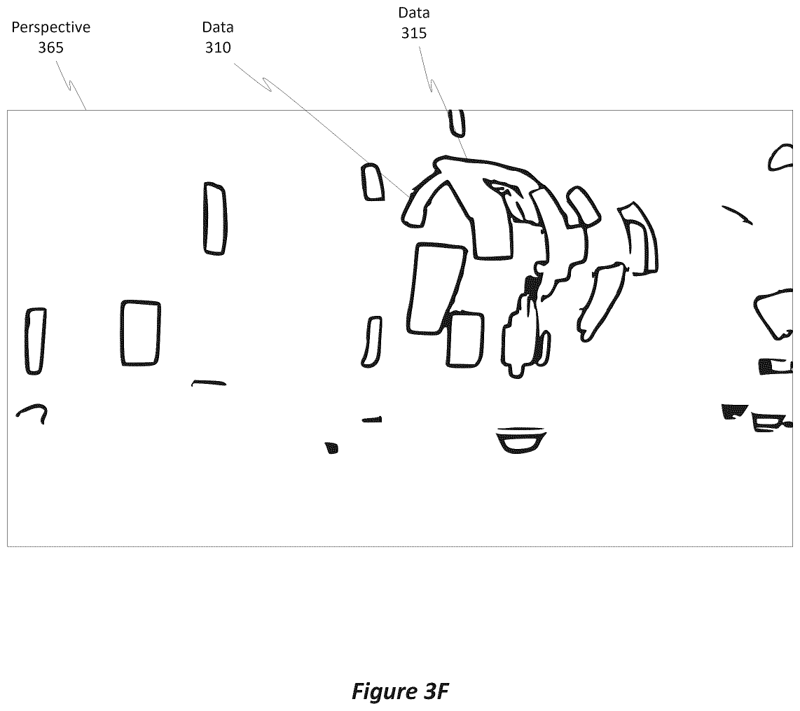

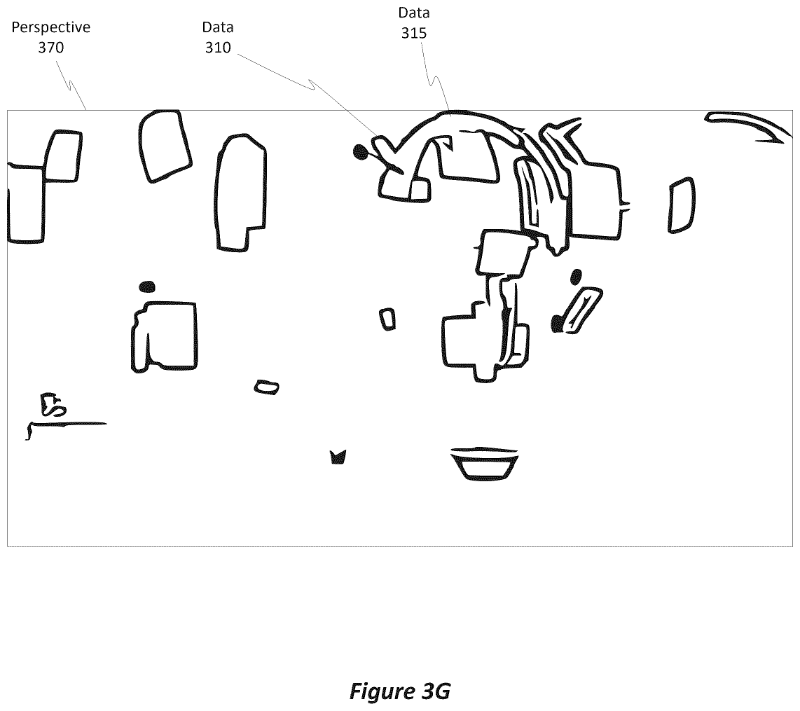

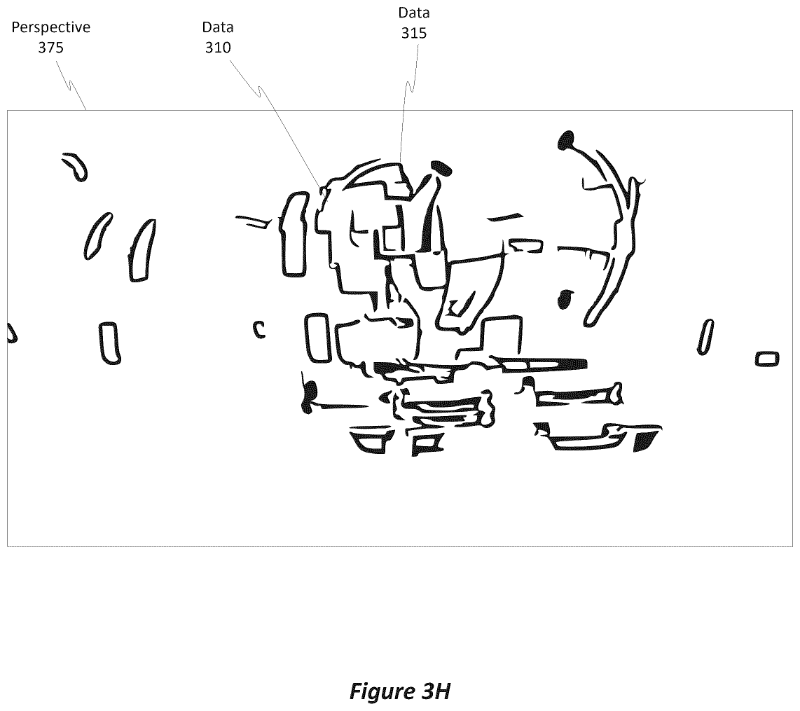

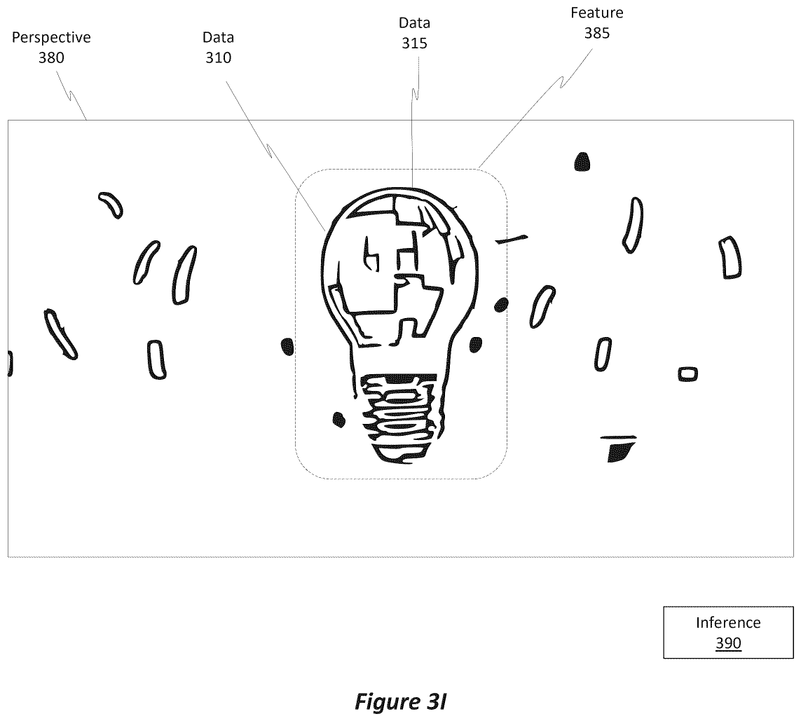

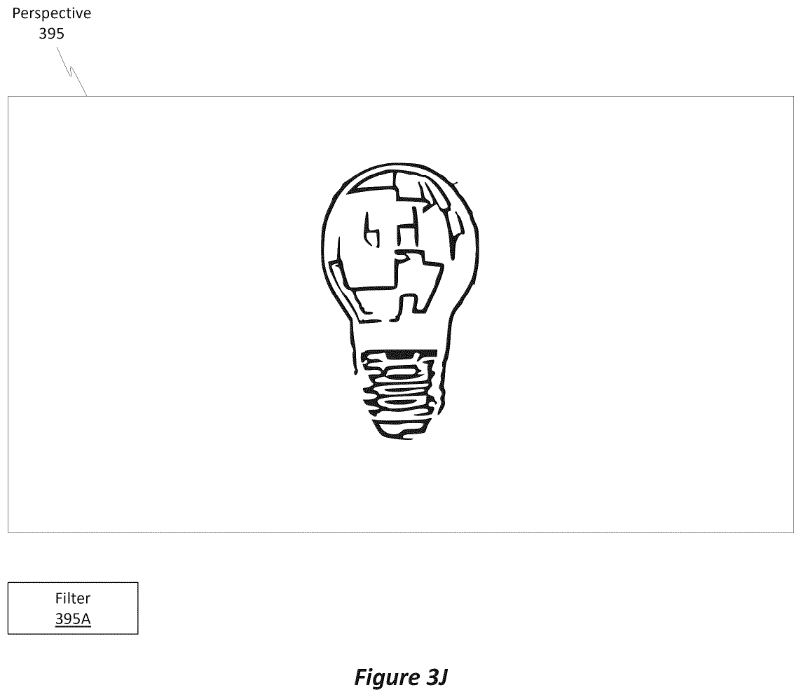

Having just described various aspects of the computing architecture 100 of FIG. 1, attention will now be directed to FIGS. 3A through 3J, which include various supplemental illustrations to support the description provided with respect to FIG. 1.

FIG. 3A shows an example plot 300 of data that has been plotted by the service 105 of FIG. 1. Plot 300 shows a first perspective 305 of multiple units of dimensionally reduced data, including data 310 and data 315. Currently, there is no frame of reference 320 for the disparate data. In fact, as plotted, the data appears to simply be a mass conglomeration of unrelated data snippets. Service 105 of FIG. 1 will modify the perspective of the plot 300 in an attempt to identify one or more features (e.g., feature 325) so as to provide a frame of reference 320 for the data.

Currently, plot 300 is provided with an axis rotation point 330. Various different rotations, as shown by axis rotation 335, will be made using the axis rotation point 330 as the point for making the rotations. As discussed previously, however, the axis rotation point 330 is subject to change and can be moved.

FIG. 3B shows a new perspective 340 of the plot, which includes the data 310 and 315. From this new perspective 340, no features are recognizable.

FIG. 3C shows a new perspective 345 of the plot, which includes the data 310 and 315. From this new perspective 345, no features are recognizable.

FIG. 3D shows a new perspective 350 of the plot, which includes the data 310 and 315. From this new perspective 350, it might be the case that a feature is becoming recognizable. For instance, the clusters of data appear to be forming a shape that somewhat resembles a question mark. Notably, the underlying data has not changed, only the perspectives from which that data is being viewed. For instance, data 310 and 315 are not being modified. The modifications that are happening are happening to how the data 310 and 315 are being viewed.

FIG. 3E shows a new perspective 355 of the plot, which includes the data 310 and 315. From this new perspective 355, a feature 360 is now potentially recognizable, and the feature 360 corresponds to a question mark. From this feature 360, the embodiments can attempt to make an inference 360A for the underlying data. This inference 360A may be that the data supposedly corresponds, in a visual manner, to a representation of a question mark.

Service 105 will not necessarily end its analysis at this point. Service 105 may continue in its efforts to identify features, as shown by the next set of figures.

FIG. 3F shows a new perspective 365 of the plot, which includes the data 310 and 315. From this new perspective 365, no features are recognizable.

FIG. 3G shows a new perspective 370 of the plot, which includes the data 310 and 315. From this new perspective 370, no features are recognizable.

FIG. 3H shows a new perspective 375 of the plot, which includes the data 310 and 315. From this new perspective 375, no features are recognizable.

FIG. 3I shows a new perspective 380 of the plot, which includes the data 310 and 315. From this new perspective 380, feature 385 is readily recognizable. Feature 385 corresponds to a lightbulb. An inference 390 can be made on the data, and the inference 390 may be that this data was designed to represent a lightbulb.

FIG. 3J shows a new perspective 395 of the plot. Here, a filter 395A has been implemented to remove some of the noisy data, thereby leading to an improved visualization of the feature.

The embodiments can also assign or determine a confidence score to the features and inferences that they derive. For instance, in this particular scenario, a high confidence score can be assigned to the inference that this feature corresponds to a lightbulb. In contrast, a much lower confidence score can be assigned to the inference 360A that feature 360 corresponded to a question mark.

In some implementations, service 105 may continue its efforts to find features if its confidence value does not meet or exceed a confidence value threshold. For instance, if the threshold is set to 75%, and the confidence of the inference 360A in FIG. 3E was only 62%, then service 105 may continue (as it did) to search for features. A timing limit may be imposed to prevent the service 105 from running for an extended duration if no features are found or if features are found but their confidence values do not meet or exceed the established threshold.

### Example Method

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

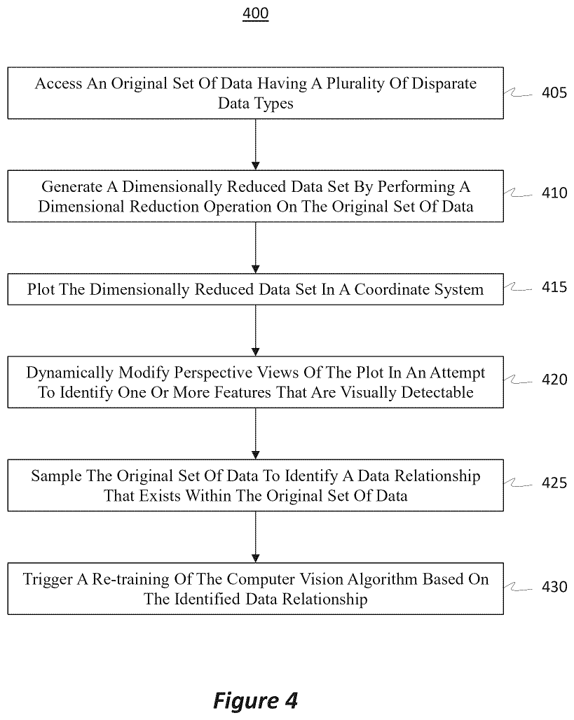

Attention will now be directed to FIG. 4, which illustrates a flowchart of an example method 400 for generating inferences based on detected features embedded within plotted data. Method 400 can be implemented within the architecture 100 of FIG. 1. Furthermore, method 400 can be performed by service 105.

In some scenarios, method 400 can be performed using an XR system, such as XR system 110. Here, the user of the XR system 110 can be fully immersed in the plot of the data, and the user can navigate around the plot in a three-dimensional manner. Visualizing the plot in a 3D manner can help users and even the computer vision algorithm identify features and make inferences. Of course, method 400 can also be implemented on a traditional computing device that includes a traditional screen.

Method 400 includes an act (act 405) of accessing an original set of data having a plurality of disparate data types. For example, the MMMD data 130 of FIG. 1 can be representative of this original set of data. One of the data types can optionally be a sensor data type. Another data type can include metadata. Optionally, the original set of data can include model behavior data. Indeed, any data type can be used. This original set of data can be multi-modal and multi-dimensional.

Act 410 includes generating a dimensionally reduced data set (e.g., dimensionally reduced data set 135) by performing a dimensional reduction operation on the original set of data. The dimensionally reduced data set is plottable in a coordinate system as a result of the dimensional reduction operation being performed. In some implementations, the coordinate system is an x-y-z coordinate system. Thus, the coordinate system can optionally be a three-dimensional coordinate system that is visible on a display. In some cases, the three-dimensional coordinate system can be visualized for a user wearing an HMD, and the user can be immersed in holograms representative of the plotted data.

Act 415 includes plotting the dimensionally reduced data set in the coordinate system. This action results in the generation of a visual plot of the dimensionally reduced data set. Plot 300 of FIG. 3A can be representative of this plot.

Any type of plot may be used. Examples of such plots include, but are not limited to, a three-dimensional scatter plot, geographic plots, polar plots, quiver plots, vector field plots, bubble charts, scatter plots, surface plots, polar line plots, line plots, class plots, or a point cloud type of plot.

Act 420 includes dynamically modifying perspective views of the plot in an attempt to identify one or more features that are visually detectable. Typically, this act is performed using a computer vision algorithm such that the features are visually detectable via the computer vision algorithm. Often, an axis rotation point is set within the plot, and the axis rotation point changes or can be changed.

In some implementations, while the perspective views of the plot are being dynamically modified, a filtering operation is performed on the plotted dimensionally reduced data set. This filtering operation can remove noisy data in the plotted dimensionally reduced data set.

The features may include multiple portions of the dimensionally reduced data set. As an example, consider the data 310 and 315 in FIG. 3I. Here, the different data are grouped or clustered together to form the feature 385. Often, these multiple portions are grouped or clustered together to form the features based on the perspective views of the plot being dynamically modified. In one perspective view of the plot, the data may form a cluster, but in a different perspective view of the plot, the data may not form a cluster. Thus, features can be identified based on the different clustering effects that can be achieved from dynamically modifying the perspective views of the data.

In some scenarios, the process of dynamically modifying the perspective views of the plot include three-dimensional rotations of the plot, such as any rotation along the x-axis, the y-axis, or the z-axis. This modification process can further include bisecting the plot any number of times. The process can further include a zooming operation, such as a zoom inward or zoom outward operation.

In some scenarios, specific portions of the data can be selected, and only those portions may have their plotted perspectives modified. Optionally, a pre-programmed perspective modification trajectory can be used (e.g., first rotate along the x-axis by 43 degrees, then along the y-axis 12 degrees, and so on in a pre-programmed manner). In some scenarios, a randomization factor can be involved during the perspective modification process. For instance, rotations can be performed randomly, and the amount by which a rotation occurs can also be random.

In response to identifying a particular feature (e.g., using the computer vision algorithm) as viewed from a particular perspective view of the plot, act 425 includes sampling the original set of data to identify a data relationship that exists within the original set of data. This data relationship is one that contributed to the feature being detectable. The identified data relationship can be an example of an inference that is made.

In some implementations, the identified feature has a shape that is recognizable by the computer vision algorithm. For instance, with respect to FIG. 3I, the shape of feature 385 corresponds to that of a lightbulb.

Act 430 then involves triggering a re-training of the computer vision algorithm based on the identified data relationship. This re-training involves training the computer vision algorithm on the detected features and enables the computer vision algorithm to better detect features during subsequent iterations.

In some implementations, a photographic snapshot of the feature at the particular perspective view of the plot is generated. Optionally, the photographic snapshot is transmitted to a user for further review or perhaps is transmitted to a specially trained computer vision algorithm for further review.

Accordingly, by practicing the disclosed principles, significant benefits to the technical field of data analysis can be performed. Additionally, the disclosed embodiments improve how machine learning models operate as a result of the ability to re-train these models based on detected features.

### Example Computer/Computer Systems

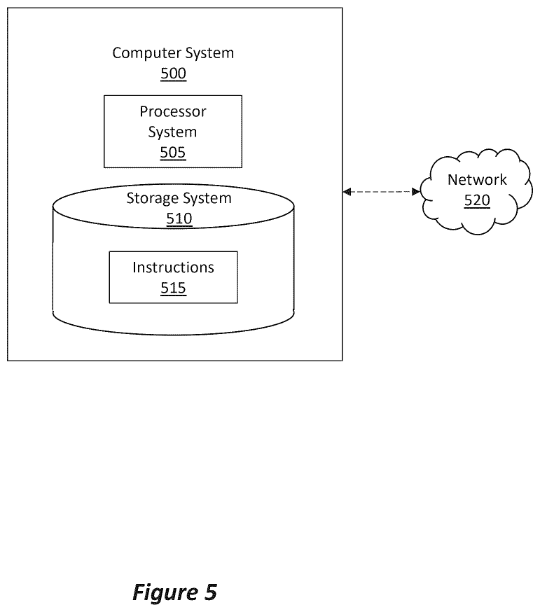

Attention will now be directed to FIG. 5 which illustrates an example computer system 500 that may include and/or be used to perform any of the operations described herein. Computer system 500 can implement architecture 100 of FIG. 1. Furthermore, computer system 500 can implement service 105.

Computer system 500 may take various different forms. For example, computer system 500 may be embodied as a tablet, a desktop, a laptop, a mobile device, or a standalone device, such as those described throughout this disclosure. Computer system 500 may also be a distributed system that includes one or more connected computing components/devices that are in communication with computer system 500.

In its most basic configuration, computer system 500 includes various different components. FIG. 5 shows that computer system 500 includes a processor system 505 that includes one or more processor(s) (aka a “hardware processing unit”) and a storage system 510.

Regarding the processor(s) of processor system 505, it will be appreciated that the functionality described herein can be performed, at least in part, by one or more hardware logic components (e.g., the processor(s)). For example, and without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

As used herein, the terms “executable module,” “executable component,” “component,” “module,” “service,” or “engine” can refer to hardware processing units or to software objects, routines, or methods that may be executed on computer system 500. The different components, modules, engines, and services described herein may be implemented as objects or processors that execute on computer system 500 (e.g. as separate threads).

Storage system 510 may be physical system memory, which may be volatile, non-volatile, or some combination of the two. The term “memory” may also be used herein to refer to non-volatile mass storage such as physical storage media. If computer system 500 is distributed, the processing, memory, and/or storage capability may be distributed as well.

Storage system 510 is shown as including executable instructions 515. The executable instructions 515 represent instructions that are executable by the processor(s) of processor system 505 to perform the disclosed operations, such as those described in the various methods.

The disclosed embodiments may comprise or utilize a special-purpose or general-purpose computer including computer hardware, such as, for example, one or more processors and system memory, as discussed in greater detail below. Embodiments also include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Furthermore, computer-readable storage media, which includes physical computer storage media and hardware storage devices, exclude signals, carrier waves, and propagating signals. On the other hand, computer-readable media that carry computer-executable instructions are “transmission media” and include signals, carrier waves, and propagating signals. Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 500 may also be connected (via a wired or wireless connection) to external sensors (e.g., one or more remote cameras) or devices via a network 520. For example, computer system 500 can communicate with any number devices or cloud services to obtain or process data. In some cases, network 520 may itself be a cloud network. Furthermore, computer system 500 may also be connected through one or more wired or wireless networks to remote/separate computer systems(s) that are configured to perform any of the processing described with regard to computer system 500.

A “network,” like network 520, is defined as one or more data links and/or data switches that enable the transport of electronic data between computer systems, modules, and/or other electronic devices. When information is transferred, or provided, over a network (either hardwired, wireless, or a combination of hardwired and wireless) to a computer, the computer properly views the connection as a transmission medium. Computer system 500 will include one or more communication channels that are used to communicate with the network 520. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules may be located in both local and remote memory storage devices.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
accessing an original set of data having a plurality of disparate data types;
generating a dimensionally reduced data set by performing a dimensional reduction operation on the original set of data, wherein the dimensionally reduced data set is plottable in a coordinate system as a result of the dimensional reduction operation being performed;
plotting the dimensionally reduced data set in the coordinate system, resulting in generation of a visual plot of the dimensionally reduced data set;
dynamically modifying perspective views of the plot in an attempt to identify one or more features that are visually detectable via a computer vision algorithm, wherein the one or more features include multiple portions of the dimensionally reduced data set, said multiple portions being grouped together to form the one or more features based on the perspective views of the plot being dynamically modified;
in response to identifying a particular feature, sampling the original set of data to identify a data relationship that exists within the original set of data, said data relationship being one that contributed to the feature being detectable; and
triggering a re-training of the computer vision algorithm based on the identified data relationship.

2. The method of claim 1, wherein one data type included among the plurality of disparate data types includes a sensor data type.

3. The method of claim 1, wherein the coordinate system is an x-y-z coordinate system.

4. The method of claim 1, wherein dynamically modifying the perspective views of the plot include three-dimensional rotations of the plot.

5. The method of claim 1, wherein dynamically modifying the perspective views of the plot include bisecting the plot.

6. The method of claim 1, wherein dynamically modifying the perspective views of the plot include a zooming operation.

7. The method of claim 1, wherein dynamically modifying the perspective views of the plot includes following a pre-programmed perspective modification trajectory.

8. The method of claim 1, wherein dynamically modifying the perspective views is performed using a randomization factor.

9. The method of claim 1, wherein the coordinate system is a three-dimensional coordinate system that is visible on a display.

10. The method of claim 1, wherein the particular feature has a shape that is recognizable by the computer vision algorithm.

11. The method of claim 1, wherein the original set of data is a multi-modal multi-dimensional set of data.

12. The method of claim 1, wherein the plot is a three-dimensional scatter plot.

13. A computer system comprising:
a processor system; and
a storage system that stores instructions that are executable by the processor system to cause the computer system to:
access an original set of data having a plurality of disparate data types;
generate a dimensionally reduced data set by performing a dimensional reduction operation on the original set of data, wherein the dimensionally reduced data set is plottable in a coordinate system as a result of the dimensional reduction operation being performed;
plot the dimensionally reduced data set in the coordinate system, resulting in generation of a visual plot of the dimensionally reduced data set;
dynamically modify perspective views of the plot in an attempt to identify one or more features that are visually detectable via a computer vision algorithm, wherein the one or more features include multiple portions of the dimensionally reduced data set, said multiple portions being clustered together to form the one or more features based on the perspective views of the plot being dynamically modified;
in response to identifying a particular feature as viewed from a particular perspective view of the plot, sample the original set of data to identify a data relationship that exists within the original set of data, said data relationship being one that contributed to the feature being detectable; and
trigger a re-training of the computer vision algorithm based on the identified data relationship.

14. The computer system of claim 13, wherein a photographic snapshot of the feature at the particular perspective view of the plot is generated, and wherein the photographic snapshot is transmitted to a user for further review.

15. The computer system of claim 13, wherein the plot is a point cloud type of plot.

16. The computer system of claim 13, wherein an axis rotation point is set within the plot, and wherein the axis rotation point changes.

17. The computer system of claim 13, wherein, while the perspective views of the plot are being dynamically modified, a filtering operation is performed on the plotted dimensionally reduced data set, said filtering operation removing noisy data in the plotted dimensionally reduced data set.

18. The computer system of claim 13, wherein the original set of data includes model behavior data.

19. A method comprising:
accessing an original set of data having a plurality of disparate data types;
generating a dimensionally reduced data set by performing a dimensional reduction operation on the original set of data, wherein the dimensionally reduced data set is plottable in a coordinate system as a result of the dimensional reduction operation being performed;
plotting the dimensionally reduced data set in the coordinate system, resulting in generation of a visual plot of the dimensionally reduced data set;
dynamically modifying perspective views of the plot in an attempt to identify one or more features that are visually detectable, wherein the one or more features include multiple portions of the dimensionally reduced data set, said multiple portions being grouped together to form the one or more features based on the perspective views of the plot being dynamically modified; and
in response to a particular feature being identified, sampling the original set of data to identify a data relationship that exists within the original set of data, said data relationship being one that contributed to the feature being detectable.

20. The method of claim 19, wherein identifying the particular feature is performed using a computer vision algorithm.
